(19) United States
(12) Patent Application Publication
(10) Pub. No.: US 2023/0103361 A1
(43) Pub. Date: Apr. 6, 2023

(54) Supply Chain Alert Management

(71) Applicant: Saudi Arabian Oil Company, Dhahran (SA)

(72) Inventors: Rami Zayed Amri, Dhahran (SA); Ali M. Alshehri, Dammam (SA)

(21) Appl. No.: 17/495,596

(22) Filed: Oct. 6, 2021

(51) Int. Cl. G06Q 10/08; G06F 3/048; G08B 21/18

(52) U.S. Cl. CPC G06Q 10/08; G06F 3/048; G08B 21/182

(57) ABSTRACT

A system and methods for supply chain alert management are provided. An exemplary system enables operations that include identifying an observation associated with the production or distribution of goods. An alert is defined based on the observation in real-time replicated backend data, wherein the alert is configured by logic set using a frontend of a supply chain management system. Additionally, a recipient of the alert and a frequency of alert transmissions are defined, an alert is generated when a condition created by the observation violates a predetermined threshold.

### TECHNICAL FIELD

The present disclosure describes a supply chain system and, more particularly, alert management in a supply chain system.

### BACKGROUND

Generally, supply chain management includes supply chain planning and supply chain execution. Supply chain planning coordinates assets to optimize the delivery of goods, services, and information from supplier to customer, balancing supply and demand. Supply chain execution describes how organizations carry out the flow of goods from procurement to delivery, including activities like production, warehousing, and transportation.

### SUMMARY

An embodiment described herein provides a computer-implemented method for enabling a supply chain alert management system. The method includes identifying an observation associated with the production or distribution of goods and defining an alert based on the observation in real-time replicated backend data, wherein the alert is configured by logic set using a frontend of a supply chain management system. The method includes defining a recipient of the alert and a frequency of alert transmissions. The method includes generating an alert when a condition created by the observation violates a predetermined threshold, wherein the alert is transmitted to the recipient at the frequency of alert transmissions.

An embodiment described herein provides a supply chain alert management system. The system includes one or more memory modules and one or more hardware processors communicably coupled to the one or more memory modules, the one or more hardware processors configured to execute instructions stored on the one or more memory models to perform operations. The operations include identifying an observation associated with the production or distribution of goods and defining an alert based on the observation in real-time replicated backend data, wherein the alert is configured by logic set using a frontend of a supply chain management system. The operations include defining a recipient of the alert and a frequency of alert transmissions. The operations include generating an alert when a condition created by the observation violates a predetermined threshold.

An embodiment described herein provides an apparatus including a non-transitory, computer readable, storage medium that stores instructions that, when executed by at least one processor, cause the at least one processor to perform operations. The operations include identifying an observation associated with the production or distribution of goods and defining an alert based on the observation in real-time replicated backend data, wherein the alert is configured by logic set using a frontend of a supply chain management system. The operations include defining a recipient of the alert and a frequency of alert transmissions. The operations include generating an alert when a condition created by the observation violates a predetermined threshold.

### BRIEF DESCRIPTION OF DRAWINGS

FIG. 1 is an illustration of an exemplary supply chain.

FIG. 2 illustrates a flowchart that describes an example process for a supply chain alert management system according to the present disclosure.

FIG. 3 is an illustration of a graphical user interface.

FIG. 4 is an illustration of actions associated with an alert.

FIG. 5 is an illustration of an exemplary supply chain alert management system architecture according to the present techniques.

FIG. 6 is a schematic illustration of an example controller or control system that enables supply chain alert management according to the present disclosure.

### DETAILED DESCRIPTION

Embodiments described herein enable a supply chain alert management system. Generally, a supply chain includes all aspects of a production process, including the actions associated with each phase, the flow of information communicated at each phase, the commodities that are transformed into goods, human resources, and other goods, resources, or components that are used to generate a final product or service. A supply chain is a system of generating a final product or service from procurement to delivery, including activities like production, warehousing and transportation.

In embodiments, an observation is any event noticed in the supply chain that requires attention to mitigate or avoid supply chain disruptions. The observation can cause an alert to be generated. For example, a delay of a critical order by a buyer or supplier is an observation that generates an alert to a supply chain team. Generally, the supply chain team includes persons or organizations that can make decisions affecting the supply chain. For example, a supply chain manager can take actions to ensure the continued operation of the supply chain, even when orders are delayed.

Conventionally, users make observations and generate alerts in a supply chain manually by running various reports in the supply chain system.

The present techniques enable supply chain alert management. In embodiments, an alert is automatically generated based on an observation. An alert is a message, indicator, or information sent to one or more organizations associated with the alert. The alerts are based on observations made using predefined criteria and logic and generated according to a user configuration of the supply chain alert management system. In embodiments, the supply chain alert management system includes a framework for organizations to manage the alerts by defining the logic of alert, the recipients of the alert, along with a source, time, and frequency of sending these alerts.

This framework can be used by control centers in different organizations to display alerts in real time in order to avoid supply chain disruption. The alert configuration is generated by the user without the need of development in the backend system.

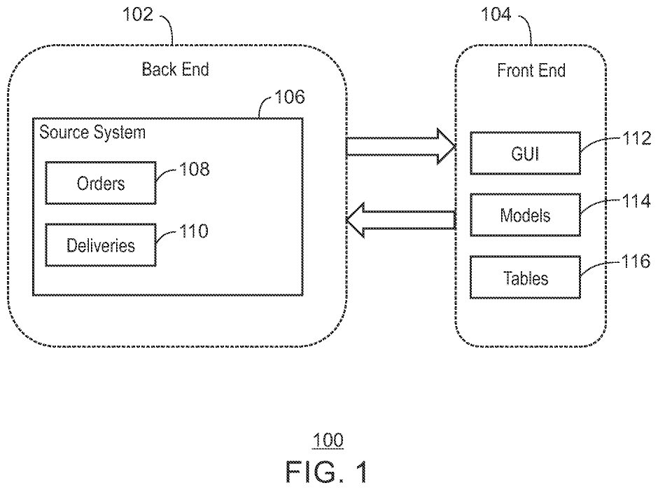

FIG. 1 is an illustration of an exemplary supply chain 100. In the example of FIG. 1, particular supply chain components are described for exemplary purposes.

However, a supply chain according to the present techniques may contain more or fewer components than what is described herein. For example, the supply chain according to the present techniques can include systems that enable the oversight of materials, information, and finances as they move in a process from a supplier, to manufacturer, to wholesaler, to retailer to consumer. Supply chain management includes, for example, purchasing, materials planning, inventory management, physical inventory, material master, logistics, transportation, other applications, and interfaces. The alerts provided by the present techniques improve the efficiency of supplying goods and services by ensuring the availability of the right material, in the right quantity, at the right time, and at the right place.

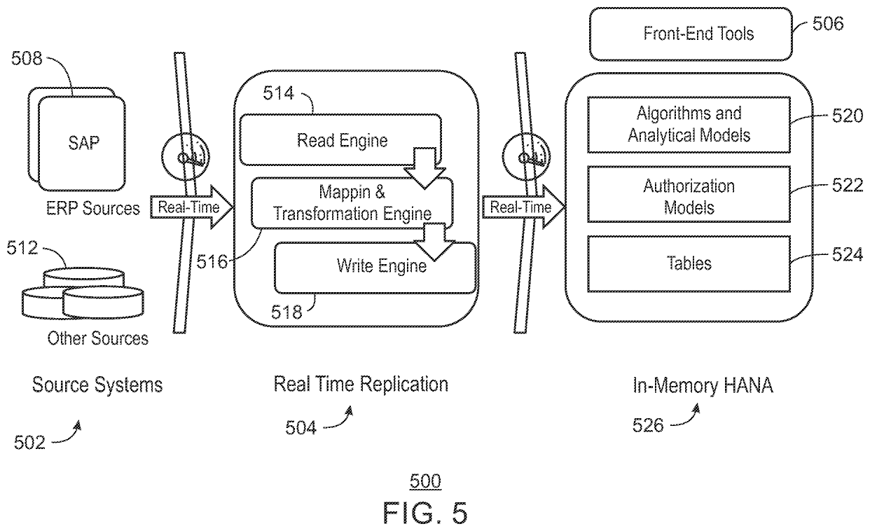

A supply chain 100 generally includes a backend 102 and a frontend 104. Generally, the backend system 102 of a supply chain 100 includes one or more source systems that generate and maintain data associated with the supply chain. In embodiments, data used to generate observations is read from the backend system. In embodiments, the backend system 102 is a transactional system where the actual orders and deliveries associated with the supply chain are created. Accordingly, in the example of FIG. 1, the backend system 102 includes a plurality of source systems 106. Each source system 106 generates, maintains, and updates data associated with orders 108, deliveries 110, or any combinations thereof. In embodiments, the backend system is an enterprise resource system (ERP) as described below with respect to FIG. 5.

In the backend system 102, an oversight of materials, information, and finances occurs as they move in a process from a supplier, to manufacturer, to wholesaler, to retailer to consumer. Generally, process flow of supply chain management begins with a customer order or material requirements planning where information is read from or written to the backend system. Within the backend system, several observations can be made.

For example, an observation is made in data stored in the backend system (backend data) from one or more source systems that supports the flow of goods from a request for goods to the delivery of goods. For example, in the case of customer order, a demand for goods or services can result in a purchase order. In the case of material requirements planning, available inventory of materials is determined before a purchase order is issued. This determination can be made using backend data. In embodiments, the backend data is replicated backend data. In response to a purchase order, a request is transmitted to a vendor which in turns supplies materials for transport that are ultimately received by the customer. This request is made using backend data. The materials for transport are received by the customer at a warehouse. In this manner, the customer receives materials to be added to the customer's physical inventory. At any point during the flow of goods or services according to the supply chain, observations are generated. In embodiments, the observations are in response to one or more thresholds or conditions set by a user as described with respect to the frontend system 104. In addition to the flow of goods, observations can be made in response to one or more events associated with the flow of goods and services, such as plant maintenance, sales and distribution, production planning, quality management, asset management, cost control, financial accounting.

The supply chain also includes a frontend system 104. As illustrated, the to frontend system includes a graphical user interface (GUI) 112, models 114, and tables 116. In embodiments, the frontend 104 enables managing the alerts by defining the logic that generates an alert and configuring alerts without development in the backend system. For example, observations that occur in the supply chain can cause an identification of a condition. The condition is compared to a corresponding predetermined threshold set by a user via the frontend system 104. If the condition violates the threshold, an alert is generated.

Recipient(s) of the alert along with source, time and frequency of sending these alerts are also configured using the frontend system 104. An alert is generated after an observation has occurred. For example, if a critical order is delayed by the buyer or supplier, an observation is generated that reflects a delay. In an example, a condition caused by the observation is a reduction in inventory resulting from the delay. The reduced inventory levels can be compared to a threshold set by a user. In embodiments, the threshold is a predefined threshold. If the reduced inventory levels violate the threshold, an alert is automatically generated and sent to the identified recipients of the alert according to the time and frequency set by the user. In embodiments, the alert also indicates the source of the observation.

Accordingly, supply chain alerts can be generated in response to observations generated during supply chain management or observations generated during supply chain execution. Though the automated alerts as described herein, inventory is optimized and risks of inventory loss are minimized. In embodiments, this supply chain alert management system as described herein enables users to add new alerts without development in the backend system. Development in the backend system often uses and includes logic written and developed by trained information technology (IT) specialists. The present techniques enable alert management by lay-people, or people who are not trained IT specialists. Thus, the present techniques saves work since new alerts are expected to be presented frequently and people not trained in IT can manage the alerts as needed. Moreover, the supply chain management alert system as described herein uses frontend technologies that render continuous real-time data. The alerts and rendered data are compatible for viewing on mobile devices.

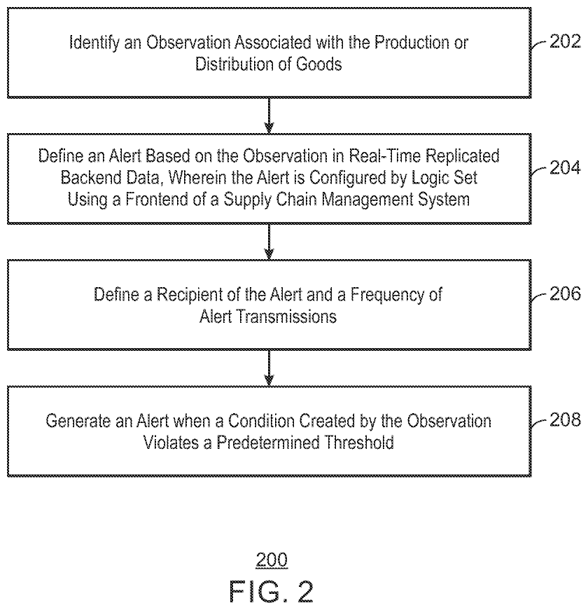

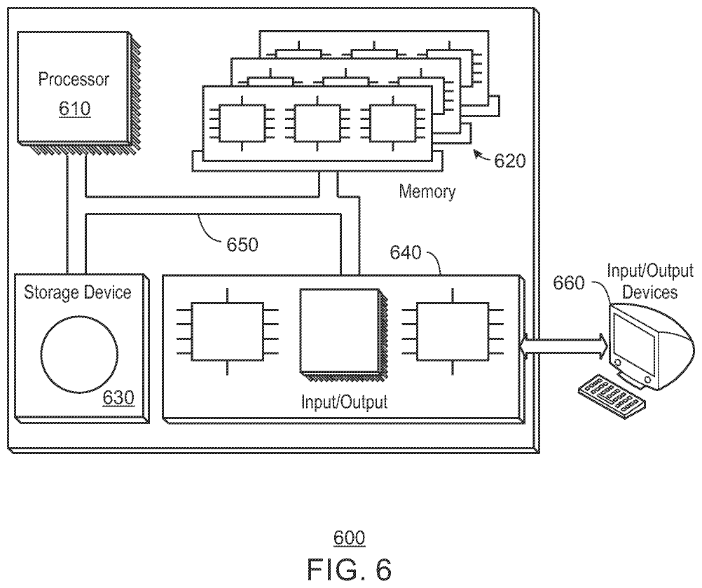

FIG. 2 illustrates a flowchart that describes an example process 200 for a supply chain alert management system according to the present disclosure. In some aspects, process 200 may be performed with or by all or parts of the supply chain 100, including the frontend system 104 that is communicably coupled to receive, for example, replicated data from the backend system 102. The process 200 can also be executed using the controller 600 of FIG. 6 described below.

At block 202, an observation associated with the production or distribution of goods is identified. In an example, an observation is an event that can cause future supply chain disruptions if not addressed. For example, a materials shortage can cause supply chain production to cease if not corrected. In embodiments, the observation is generated using replicated backend data as described with respect to FIG. 5 below.

At block 204, an alert is defined based on the observation in real-time replicated backend data, wherein the alert is configured by logic set using a frontend of a supply chain management system. In embodiments, a user can set (define) one or more parameters that control alert generation. For example, if an observation is made that a number of emergency orders is increasing. A condition caused by this observation is an excess of emergency orders. When the excess of emergency orders exceeds a predetermined threshold, an alert is sent to a predetermined recipient. In examples, the predetermined recipient is the procurement team. In an embodiment, the condition is compared to the predetermined threshold to trigger or generate alerts that are transmitted to or rendered for the predefined recipients. For example, the default threshold for the number of emergency orders is 100, but user can re-define this threshold as applicable to the organization.

The alerts are defined without development or modification of a backend. For example, instead of employing IT specialists to build logic for generating alert, a layperson can utilize this technology to change thresholds as needed. Conventionally, alerts are generated in response to manual reports. In these conventional examples, data is read from the backend system, and code created by a specialized user that sets a threshold used to generate an alert. Conventionally, the thresholds are limited to being changed by changing the code that reads data from the backend system. An IT department that includes the specialized users is generally required to make these changes to the code. The present techniques enable logic defining the alert to be set using the frontend of the supply chain management system, while the backend of the supply chain management system is unchanged.

At block 206, a recipient of the alert is defined. In embodiments, a source of the alert, timing associated with the alerts, and frequency of sending the alerts is also defined. An alert transmission is the sending of an alert to a user, and can also include the rendering, generation, or display of the alert. The present techniques eliminate the need to modify code created by IT specialists to change the alert threshold, recipients, or frequency. The present techniques enable configuration of the alerts settings (i.e. threshold, recipients or frequency) using a web-based frontend.

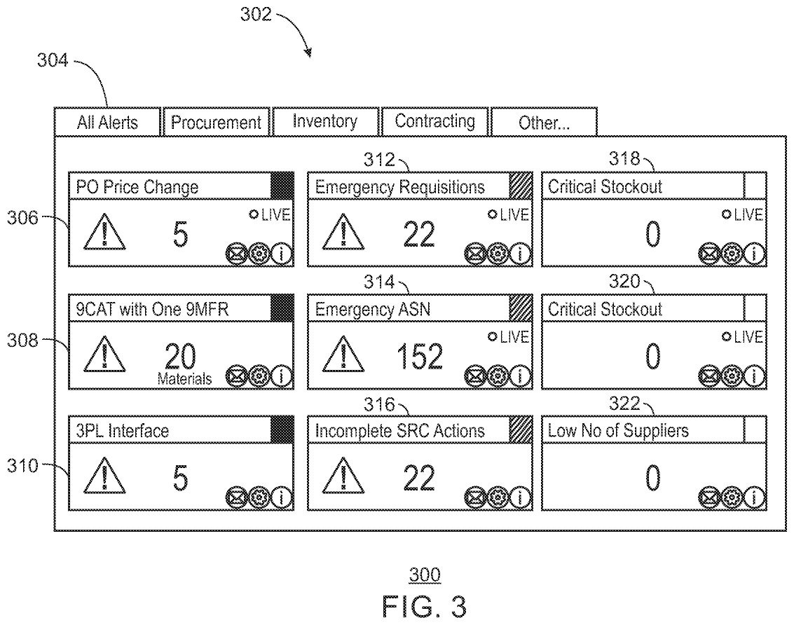

Accordingly, in embodiments the frontend executes on a web server accessed via a network connection. For example, the web server receives and transmits data according to the hypertext transfer protocol (HTTP) or a secure HTTP (HTTPS). The frontend includes various web resources, such as application programming interfaces (APIs), that are used to build and deploy the alerts. In examples, the web-based frontend enables users to configure (change) the alert setting without technical knowledge used by IT specialists. In this manner, requests to IT for alert creation or alert configuration are eliminated. The web-based solution is further described with respect to FIG. 5. In examples, users configure the alerts via a GUI 112 (FIG. 1) or GUI 300 (FIG. 3). At block 208, an alert is generated when a condition created by the observation violates a predetermined threshold, wherein the alert is transmitted to the recipient at the frequency of alert transmissions.

FIG. 3 is an illustration of a GUI 300 as described with respect to FIGS. 1 and 2. In the exemplary GUI 300, a plurality of supply chain functions 302 are illustrated, such as procurement, inventory, contracting, and other. A tab of the GUI 300 is selected which renders all alerts 304. The present techniques enable the integration of different supply chain functions including, but not limited to, procurement, warehouse, inventory, and supplier. Conventional alert management techniques are limited to a single supply chain function.

In the example of FIG. 3, a total of nine alerts 306-322 are illustrated. The alerts include a purchase order (PO) price change 306, catalogued material (SCAT) with materials linked to manufacture (9MFR) 308, 3PL Interface 310, emergency requisitions 312, emergency advanced shipments notice (ASN) 314, incomplete services review committee (SRC) actions 316, critical stockouts 318 and 320, and low numbers of suppliers 322. In examples, the ASN is acknowledgment from the supplier to confirm that the material is available for shipment. Additionally, in examples the SRC is a committee of company's management that request actions to be completed by employees. In embodiments, the alerts are categorized as critical, normal, or low. As described above, an alert is alert is generated after an observation has occurred. In the example of FIG. 3, the alert is a message that is displayed in the GUI 300, which may include a dashboard. The alert can also be a message sent to a recipient's email. Further, the alerts may be intelligent alerts generated using artificial intelligence. For example, price prediction alerts that are generated when a price prediction exceeds certain value are machine learning based.

Alerts are managed according to their respective source, threshold, recipients and frequency. In embodiments, the alerts can be generated by either running a report or by the system. For example, making observations can automatically result from the manual running of different reports in the system, or the observations can be generated autonomously by the system. In an embodiment, a user configures the system using the frontend web based solution as described herein. Defining the logic of generating alert and the recipient of the alert along with a source, time, and frequency of sending these alerts enables an organization to engage in efficient alert management by providing the organization with a tool to configure all alerts that affect their operation, with an added flexibility of modifying the alerts and creating new alerts as needed. The present techniques enables real time alerts with user control on when to display these alerts while avoiding the cost of IT development to enable or change the real time alerts. In embodiments, the alerts are defined by business experts without requiring IT intervention and development.

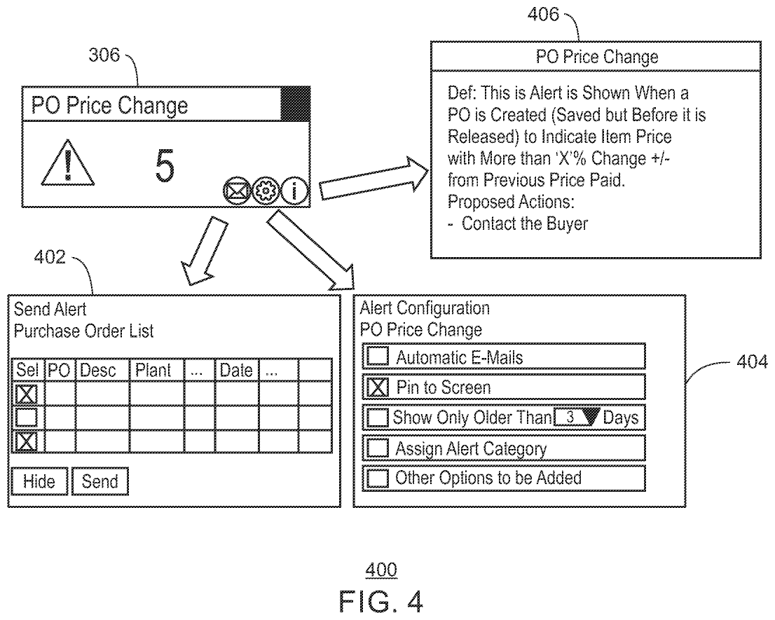

FIG. 4 is an illustration of actions associated with an alert. In the example of FIG. 4, the alert is a critical alert regarding a PO Price change. In embodiments, the alert is visualized in either dashboard or control center with a number of displays that render data used to monitor a supply chain. In embodiments, the alerts are generated in real time and pushed to a control center via the backend system. The control center may include, for example, a supply chain control tower.

As illustrated, the alert includes data 402. In embodiments, the data 402 is replicated from the backend system. Observations can be made using the data 402. As discussed above, a violation of one or more conditions can generate the alert. The alert also includes a configuration interface 404. In embodiments, the configuration interface enables the creation of automatic emails when the alert is generated. In an embodiment, the alert is pinned to the screen. In an embodiment, the user can select a time range associated with the display of the alert. A user can also assign an alert category to the alert. Moreover, a user can select from other options for alert management not described herein.

Information 406 can be rendered to give the user additional information regarding the alert. In the example of FIG. 4, the alert is defined as being “shown when a PO is created (saved but before it is released) to indicate item price with more than ‘X’% change +/− from previous price paid. Proposed Actions: Contact the Buyer.” In this manner the alert also provides corrective actions associated with the alert.

In addition to the visualization of the alerts, the supply chain alert management system enables users to have control over the intelligent alerts. For example, users can suppress alerts or create new alerts. As described below with respect to FIG. 5, the source of alert could be via a Systems, Applications, and Products (SAP), non-SAP systems, or manual entry. In examples, the supply chain alert management system enables a view log of the alerts issued in the system. Categories of the alerts can be changed, and the alerts can be re-named. The present techniques enable maintenance of the alerts definitions and proposed follow-up actions. In embodiments, a time and frequency of alerts is also provided. Further, the present techniques enable mange and change list of alerts receivers. The list of receivers can be based on position holders, email groups, individual users or job titles.

FIG. 5 is an illustration of an exemplary supply chain alert management system architecture 500 according to the present techniques. The architecture of FIG. 5 generates automatic alerts based on predefined conditions. The supply chain alert management system will enable end users to change these conditions via a web-based user interface without need to access the backend system or change code. In embodiments, a user adds and defines new alerts in the supply chain alert management system. Additionally, a user can modify a list of recipients of the alerts. The list of recipients can be position holders, email groups, individual users or job titles. In examples, a user creates and changes the frequency of sending alerts.

In the example of FIG. 5, the supply chain source systems 502 includes a Systems, Applications, and Products (SAP) system 508 and other sources 512. The SAP system 508 may be an Enterprise Resource Planning (ERP) source. In examples, an ERP source is an aggregation of systems and applications that coordinate, control, and support resources and information related to business processes such as manufacturing, supply chain management, financials, projects, human resources and customer relationship management from a shared data store for an entire enterprise. In embodiments, the inherently large scope and complexity of ERP systems poses significant challenges to modernization. Organizations balance business and technical benefits of updating and modernizing these vast systems against the considerable costs, risks, and disruption associated with large-scale modernization projections.

In examples, SAP systems and ERP sources are operable via a proprietary system architecture and programming language. SAP systems and ERP sources are associated with specialized services and solutions that are loosely aligned with, the underlying framework, architecture, and programming language of SAP systems, from both technical and business perspectives. The present techniques enable configuration of alerts without modifications or development within the SAP system 508 or other sources 512.

As illustrated, the backend data is replicated in real time via real-time replication 504. To avoid development in the backend system, the present techniques enable real-time replication of backend, source system data 502. Real time replication 504 creates a condensed, replicated version of the data contained in the source systems 502. Real time replication is realized via a read engine 512 that reads data from the source systems 502. A mapping and transformation engine 514 provides the necessary mappings and transformations to the data stored in the source systems 502. A write engine 516 enables writing data for replication. In examples, data is replicated to a reporting system, where replication can include, for example, transforming data to the required format in the alert that will be sent to the end user. In examples, the reporting system is an independent system between the frontend and the backend with independent processing resources. In examples, the reporting system is collocated with the frontend, the backend, or a combination of the frontend and backend with shared processing resources. In this manner, the user can configure algorithms and analytical models 520, authorization models 522, and tables 524 to create alerts based on observations in the replicated backend data. In embodiments, the user accesses a web-based solution in the front end tools 506 to configure alerts as described herein.

In embodiments, frontend tools 506 execute via an in memory high-performance analytic appliance (HANA) 526. The frontend tools include, for example, the algorithms and analytical models 520, authorization models 522, and tables 524 as described above. In examples, in memory HANA is an in-memory, column-oriented, relational database management system.

The present techniques enable end to end visibility of supply chain operations by providing real time alerts that can be instantly rendered on control center screens. Issues are spotted proactively before they disrupt operation using the present techniques. Further, the present techniques can enable cost avoidance by eliminating unnecessary orders before they reach customers.

The introduction of real time alert management system will enable supply chain teams to react immediately to generated alerts. For example, orders may be associated with deleted requisitions that creates wasted costs. This tool avoid wasted costs by providing real time alerts to a control tower that enables immediate corrective actions. For example, an immediate corrective action may include contacting a supplier before material is delivered to a user. In this manner, expenses such as the costs of material, and associated costs including as logistics and warehouse carrying costs are avoided. Thus, the present techniques enable cost savings in supply chain management. In embodiments the present techniques avoid the development of customized code, objects, reports, and interfaces for specific business requirements typically required by SAP and ERP systems. Accordingly, the present invention features a solution to automatically issue alerts without changes to a backend, such as backend development at a detailed, source code level as performed by IT specialists.

FIG. 6 is a schematic illustration of an example controller 600 (or control system) supply chain alert management according to the present disclosure. For example, the controller 600 may include or be part of the supply chain 100 shown in FIG. 1 operable according to the process 200 of FIG. 2. The controller 600 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 600 includes a processor 610, a memory 620, a storage device 630, and an input/output device 640 (for displays, input devices, example, sensors, valves, pumps). Each of the components 610, 620, 630, and 640 are interconnected using a system bus 650. The processor 610 is capable of processing instructions for execution within the controller 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the controller 600. In one implementation, the memory 620 is a computer-readable medium. In one implementation, the memory 620 is a volatile memory unit. In another implementation, the memory 620 is a nonvolatile memory unit.

The storage device 630 is capable of providing mass storage for the controller 600. In one implementation, the storage device 630 is a computer-readable medium. In various different implementations, the storage device 630 may be a floppy disk device, a hard disk device, an optical disk device, or a tape device.

The input/output device 640 provides input/output operations for the controller 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random to access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a backend component, such as a data server, or that includes a middleware component, such as an application server or an Internet server, or that includes a frontend component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

Other implementations are also within the scope of the following claims.

What is claimed is:

1. A computer-implemented method for enabling a supply chain alert management system, the method comprising:
identifying, with one or more hardware processors, an observation associated with the production or distribution of goods;
defining, with one or more hardware processors, an alert based on the observation in real-time replicated backend data, wherein the alert is configured by logic set using a frontend of a supply chain management system;
defining, with one or more hardware processors, a recipient of the alert and a frequency of alert transmissions; and
generating, with one or more hardware processors, an alert when a condition created by the observation violates a predetermined threshold, wherein the alert is transmitted to the recipient at the frequency of alert transmissions.

2. The computer-implemented method of claim 1, wherein the observation is identified based on one or more models that accesses the real-time replicated backend data.

3. The computer-implemented method of claim 1, wherein the predetermined threshold is configured by a user via a graphical user interface (GUI) of the frontend of the supply chain management system.

4. The computer-implemented method of claim 1, wherein the frontend of the supply chain management system includes a web server.

5. The computer-implemented method of claim 1, wherein the real-time replicated backend data is created by mapping and transforming backend data in real time.

6. The computer-implemented method of claim 1, wherein observations are based on predefined criteria and logic configured by a user via the frontend.

7. The computer-implemented method of claim 1, wherein a backend of the supply chain management system is unchanged by the logic set using the frontend of the supply chain management system.

8. The computer-implemented method of claim 1, wherein a backend of the supply chain management system includes a Systems, Applications, and Products (SAP) system, an Enterprise Resource Planning (ERP) source, or any combinations thereof.

9. A supply chain alert management system, comprising:
one or more memory modules;
one or more hardware processors communicably coupled to the one or more memory modules, the one or more hardware processors configured to execute instructions stored on the one or more memory models to perform operations comprising:
identifying an observation associated with the production or distribution of goods;
defining an alert based on the observation in real-time replicated backend data, wherein the alert is configured by logic set using a frontend of a supply chain management system;
defining a recipient of the alert and a frequency of alert transmissions; and
generating an alert when a condition created by the observation violates a predetermined threshold.

10. The system of claim 9, wherein the observation is identified based on one or more models that accesses the real-time replicated backend data.

11. The system of claim 9, wherein the predetermined threshold is configured by a user via a graphical user interface (GUI) of the frontend of the supply chain management system.

12. The system of claim 9, wherein the frontend of the supply chain management system includes a web server.

13. The system of claim 9, wherein the real-time replicated backend data is created by mapping and transforming backend data in real time.

14. The system of claim 9, wherein observations are based on predefined criteria and logic configured by a user via the frontend.

15. The system of claim 9, wherein a backend of the supply chain management system is unchanged by the logic set using the frontend of the supply chain management system.

16. The system of claim 9, wherein a backend of the supply chain management system includes a Systems, Applications, and Products (SAP) system, an Enterprise Resource Planning (ERP) source, or any combinations thereof.

17. An apparatus comprising a non-transitory, computer readable, storage medium that stores instructions that, when executed by at least one processor, cause the at least one processor to perform operations comprising:
identifying an observation associated with the production or distribution of goods;
defining an alert based on the observation in real-time replicated backend data, wherein the alert is configured by logic set using a frontend of a supply chain management system;
defining a recipient of the alert and a frequency of alert transmissions; and
generating an alert when a condition created by the observation violates a predetermined threshold.

18. The apparatus of claim 17, wherein the observation is identified based on one or more models that accesses the real-time replicated backend data.

19. The apparatus of claim 17, wherein the predetermined threshold is configured by a user via a graphical user interface (GUI) of the frontend of the supply chain management system.

20. The apparatus of claim 17, wherein the frontend of the supply chain management system includes a web server.
